(19) United States
(12) Patent Application Publication
(10) Pub. No.: US 2003/0036379 A1
(43) Pub. Date: Feb. 20, 2003

(54) Mobile radio network and mobile terminal for location-based services

(75) Inventors: Dirk Nikolai, Stuttgart (DE); Michael Tangemann, Leonberg (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/206,945

(22) Filed: Jul. 30, 2002

(30) Foreign Application Priority Data
Aug. 20, 2001 (EP) 01 440 270.5

(51) Int. Cl. H04Q 7/20

(52) U.S. Cl. 455/414; 455/456; 455/423

(57) ABSTRACT

The invention relates to a mobile radio network which provides location-based services to mobile subscribers. To simplify the use of location-based services within the mobile radio network, the network elements of the mobile radio network cause at least one of the base stations to transmit an indicator signal which indicates to the mobile subscriber that at least one location-based service is available. The mobile terminal disclosed receives the indicator signal and causes its display controller and the display connected thereto to generate a new symbol on the display which indicates to the mobile subscriber the availability of the location-based service.

### BACKGROUND OF THE INVENTION

This invention relates to a mobile radio network which provides location-services to mobile subscribers, as set forth in the preamble of claim 1.

Moreover, the invention relates to a mobile terminal enabling a mobile subscriber to use location-based services and to a symbol and its use for presentation on a display of the mobile terminal as set forth in respective independent claims.

The invention is based on a priority application EP 01440270.5 which is hereby incorporated by reference.

U.S. Pat. No. 6,131,028 discloses a mobile radio system and a mobile terminal which enable a subscriber to use a location-based service. As described there in column 1, lines 57 to 63, location-based call forwarding services are provided in addition to other location-based services. In column 3, lines 11 to 21, it is described that the subscriber must enter on the keypad of his or her mobile terminal (“wireless unit”) a feature code and then wireline telephone numbers to which incoming wireless calls are to be forwarded if the subscriber is near the location of one of the wireline numbers. The mobile radio network, which continuously tracks the subscriber's location, can then forward the call to the desired wireline telephone. However, by sending the feature code, the subscriber himself must indicate to the mobile radio network that he or she wishes to use the location-based forwarding service. This also applies to the other location-based services referred to therein (see column 1, lines 59 to 63, and column 4, lines 53 to 65), such as information services for subscribers who are on a business trip.

### SUMMARY OF THE INVENTION

It is an object of the invention to simplify the use of location-based services within a mobile radio network.

This object is attained by a mobile radio network having the features of claim 1 and by a mobile terminal having the features of claim 5.

In addition, a symbol for presentation on the display of the mobile terminal as set forth in independent claim 9 and a use of such a symbol as set forth in independent claim 10 are proposed to attain the object.

Accordingly, the mobile radio network in accordance with the invention comprises at least one base station which is in radio communication with a mobile terminal in accordance with the invention which is used by a mobile subscriber, and network elements which estimate the mobile subscriber's current location and provide location-based services, the network elements causing the at least one base station to transmit an indicator signal which indicates that at least one location-based service is available, in order to indicate to the mobile subscribers the availability of the location-based service.

The proposed mobile terminal has a receiver for receiving radio signals from the mobile radio network as well as a display controller connected to the receiver and a display connected to the display controller which generate images on the display by means of video data contained in the received radio signals. The receiver is suitable for receiving from the mobile radio network an indicator signal which indicates that a location-based service is available, in which case the display controller and the display generate on the display a symbol which indicates to the mobile subscriber the availability of the location-based service.

Also proposed are a symbol and its use for presentation on the display of the mobile terminal, with the symbol indicating to the subscriber the availability of a location-based service which is provided by the mobile radio network.

These measures in accordance with the invention have the advantage that the availability of location-based services is automatically indicated to the mobile subscribers as soon as the subscribers are in a service area of the mobile radio network where such services are offered. The subscribers need not send query signals to the mobile radio network to inquire whether such services are provided. Therefore, the signaling commonly needed for this purpose can be dispensed with, which, in turn, reduces the signaling load in the mobile radio network. Each subscriber who uses a mobile terminal in accordance with the invention can determine right away whether the mobile radio network offers location-based services at the subscriber's current location. The visual display through a symbol can be registered by the subscriber very quickly and straightforwardly and is discreet towards the subscriber's environment.

Particularly advantageous developments of the invention are apparent from the subclaims.

Accordingly, it is particularly advantageous if the indicator signal received by the receiver of the mobile terminal also indicates the quality with which the location-based service is available, and if the display controller and the display vary the shape intensity, and/or color of the symbol in accordance with the indicated quality. This enables the subscriber to recognize immediately whether the localization is accurate enough to allow the use of correspondingly high-quality services. The highest level of accuracy indicates, for example, that the localization is accurate to a few meters, which is necessary if subscribers want to use orientation and path description services for pedestrians in downtown areas. By observing the symbol on his or her mobile terminal, each subscriber also registers whether the quality of the location-based service varies widely. The subscriber can then decide whether or not to request particular services which require high accuracy. The quality, which is preferably determined by the network elements, can be dependent on the technique used. For example, triangulation or dead reckoning provides higher accuracy than localization of the mobile station by evaluation of the cell identification. Then, the indicator signal preferably indicates a corresponding quality level. The quality determined can also be dependent on the absolute accuracy. By triangulation, for example, an accuracy range of 200-20 meters is achieved. Then, the indicator signal preferably indicates the accuracy as an absolute value in meters. The symbol can be, for example, a corresponding bar on a scale from 20 to 200.

Particularly advantageously, the mobile terminal connects to a navigation device or incorporates a navigation module which determines the current location and which indicates a measure of the quality of the location-based service depending on the accuracy with which the navigation device or the navigation module determines the current location, with the display controller and the display varying the shape, intensity, and/or color of the symbol in accordance with the indicated quality. By these specific measures, high localization accuracy is achieved in the mobile terminal without the mobile terminal itself having to estimate the subscriber's location.

The symbol itself need not necessarily be a visually representable symbol. An audible indication in the form of particular signal tones is also conceivable.

Also, a vibration alarm with a particular pattern may call the subscriber's attention to the fact that location-based services are available.

### BRIEF DESCRIPTION OF THE DRAWINGS

The invention and the advantages resulting therefrom will become more apparent from the following description of embodiments taken in conjunction with the accompanying drawings (schematic representations), in which:

FIG. 1 shows a mobile radio network in accordance with the invention;

FIG. 2 shows a service area with several cells;

FIG. 3 is a block diagram of a mobile terminal in accordance with the invention;

FIG. 4 is a front view of the mobile terminal; and

FIG. 5 shows various representations of symbols in accordance with the invention.

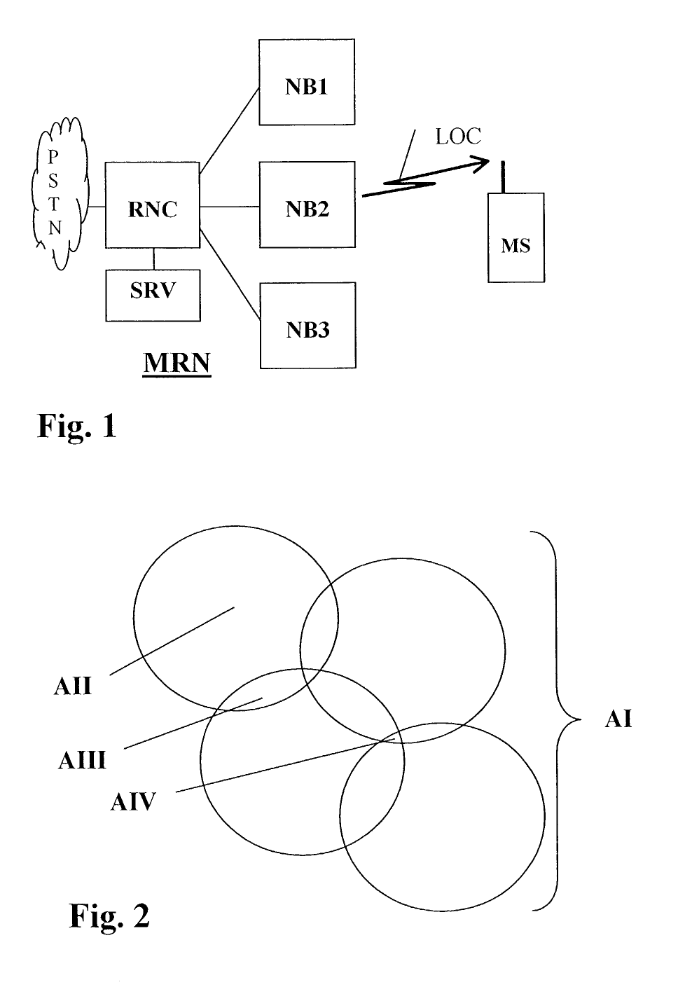

FIG. 1 shows schematically the structure of a mobile radio network MRN which provides location-based services to mobile subscribers using mobile terminals which are in radio communication with the mobile radio network MRN. One such mobile terminal MS is shown in FIG. 1 by way of example. The mobile radio network MRN includes several base stations NB1, NB2, and NB3, which are connected to network elements, particularly to a radio network controller RNC. The latter establishes connections to a public telecommunications network PSTN. The radio network controller RNC is connected to a further network element, namely to a server SRV which provides the location-based services within the mobile radio network MRN.

The following location-based services are provided, for example: information services for travelers and tourists, navigation services, guide services, goods information and shopping services, weather forecast services, emergency information services, and the like. Depending on the subscriber's current location, suitable services are offered. If, for example, the subscriber is in the center of a major city, information and guide services as well as goods information and shopping services will be offered. The service offerings can be varied in accordance with the subscriber's current location. To this end, the mobile radio network MRN continuously tracks the subscriber's current location and adapts the service offerings by means of the server SRV. The selection of location-based services depends not only on the subscriber's current location but also on the location of the service area, which may consists of one or more cells. For example, if the subscriber is within one or more cells which serve a large city, he or she will be offered services which apply to the entire service area of the city. These are, for instance, regional services such as information about cultural events, regional weather forecasts, local traffic information, and so forth. In addition, based on the subscriber's exact location, such as the street in which he or she is, corresponding services are offered, such as advertising by and information from local shops, tourist information about local places of interest, and so forth.

The invention proposes to indicate to the subscriber on his or her mobile terminal MS, before he or she wants to use a location-based service, the availability and particularly also the quality of such services. To this end, the mobile radio network MRN transmits an indicator signal LOC to the mobile terminals. By the reception of the indicator signal LOC, the mobile terminals can then determine immediately that location-based services are being offered.

According to the invention, a corresponding symbol then appears on the display of the respective mobile terminal MS. The transmission and reception of the indicator signal LOC is described in more detail below. First it will be described with the aid of FIGS. 1 and 2 how the mobile radio network MRN can locate subscribers.

FIG. 2 shows several adjacent cells which are served by a corresponding number of base stations and which together form a service area AI. Here the localization of subscribers is carried out by the mobile radio network MRN itself. The network elements perform radio signal measurements to determine in which of the cells the mobile subscriber currently is. This function is performed essentially by the network controller RNC (see FIG. 1). The accuracy of this localization can already be on the order of magnitude of a single cell, as is indicated in FIG. 2 by the reference characters AII. Cells have diameters of several kilometers down to about one hundred meters, and sometimes even less. This localization accuracy suffices to offer location-based services for correspondingly small areas, such as downtown areas.

The mobile radio network can also carry out a more accurate localization, for instance by triangulation. In this method, measured values from the base stations NB1 to NB3 (see FIG. 1) are evaluated by the radio network controller RNC. These measured values are, for example, receive levels or signal propagation times which characterize the radio links between the mobile station and the base stations NB1, NB2, or NB3. Accordingly, the measured values are a measure of the distances between the mobile terminal and the individual base stations. These distances correspond to distance radii extending from the locations of the individual base stations. Correspondingly drawn circular arcs form intersections which delimit the area of the estimated location of the subscriber station. As shown in FIG. 2, corresponding areas (see AIII or AIV) which are considerably smaller than a single cell can be computed by the mobile radio network. In this manner, the subscriber's location can be determined accurately to a few meters. Based on these more precise localizations, correspondingly highly accurate location-based services will then be offered.

The invention proposes to also communicate to the mobile terminal MS by means of the indicator signal LOC (see FIG. 1) the accuracy of the localization, which is then presented on the display. The subscriber is then informed not only of the availability of a location-based service as such, but also of the quality of the service being offered. The localization of the subscriber can be carried out by the mobile radio network MRN itself, as described with reference to FIGS. 1 and 2. It can also be performed by the mobile terminal MS if the latter incorporates suitable navigation means.

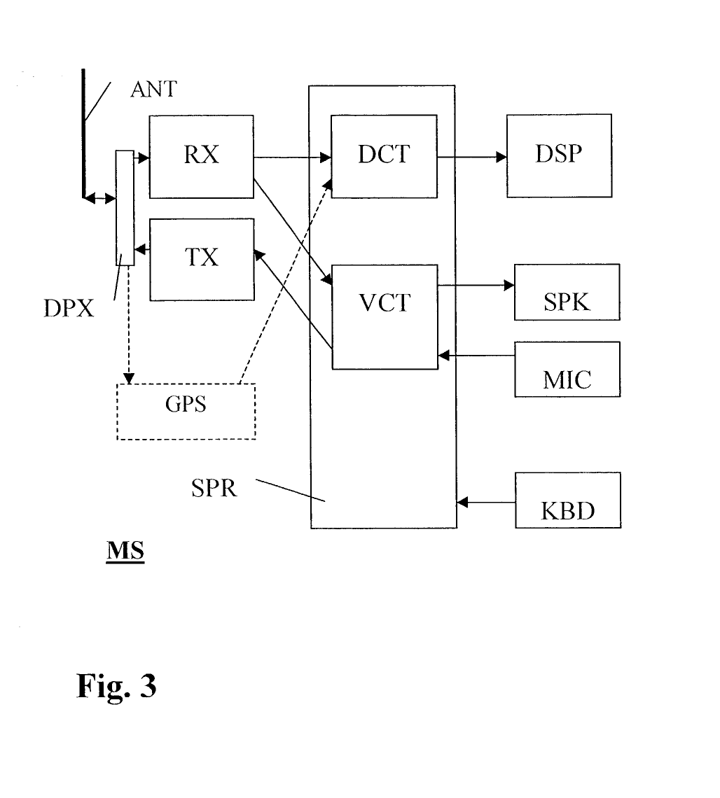

FIG. 3 shows a mobile terminal MS equipped for this purpose. It has a navigation module GPS which can determine the position of the mobile terminal MS accurately to a few meters by satellite-based navigation. Instead of a navigation module GPS, it is also conceivable to connect an external navigation device to the mobile terminal MS. The arrangement illustrated schematically in FIG. 3 also shows the following functional elements of the mobile terminal MS:

A receiver RX and a transmitter TX, which are both connected via a duplexer DPX to the antenna ANT of the mobile terminal MS. Both the receiver RX and the transmitter TX are connected via a digital signal processing unit SPR to the peripheral elements of the mobile terminal MS, namely to a display DSP, a loudspeaker SPK, a microphone MIC, and a keypad KBD. The digital signal processing unit SPR comprises in particular a display controller DCT, which is connected to the receiver RX and the display DSP and controls the latter, and a voice processing unit VCT, which connects the receiver RX and the transmitter TX to the voice output means, i.e., to the loudspeaker SPK, and to the voice input means, i.e., to the microphone MIC, respectively. The aforementioned navigation module GPS is connected to the duplexer DPX to receive signals from satellites via the antenna ANT. It is also connected to the display controller DCT to supply the latter with localization data.

The functional elements shown in FIG. 3, particularly the receiver RX, the display controller DCT, the display DSP, and the navigation module GPS, cooperate as follows.

When the mobile terminal MS receives the indicator signal (LOC in FIG. 1) from the mobile radio network via its antenna ANT and the receiver RX, the indicator signal is passed on to the display controller DCT. The latter then generates a symbol which is presented on the display DSP and indicates to the subscriber that location-based services are available in the mobile radio network. In addition, the display controller receives from the navigation module GPS position data about the subscriber's current location or at least data about the accuracy of the position determination.

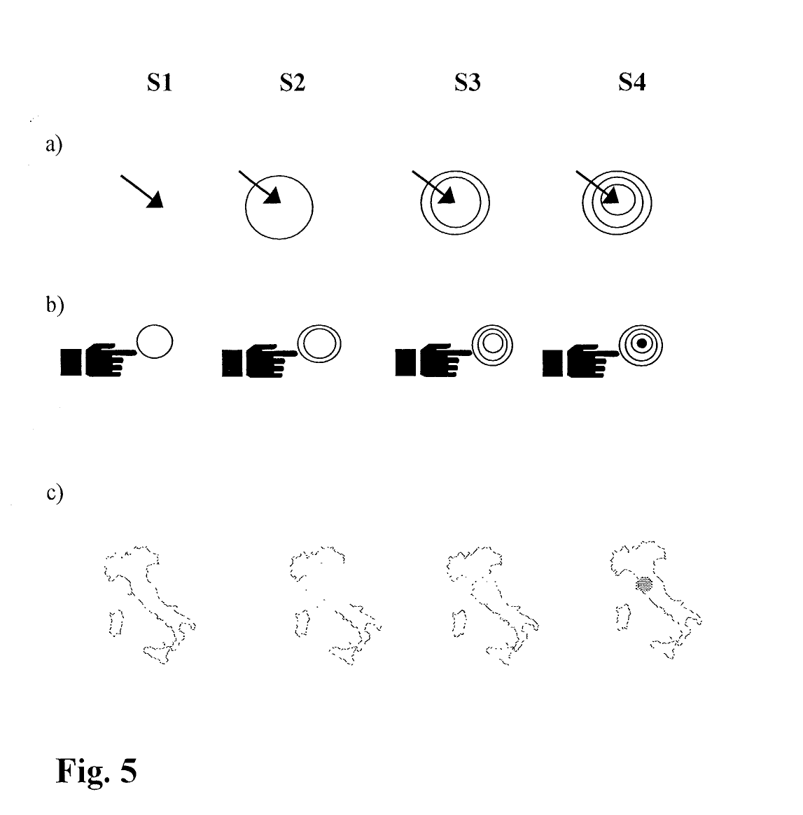

Based on the accuracy of the position determination, the display controller DCT causes a change in the symbol on the display DSP whereby the subscriber is informed not only of the availability of the location-based service, but also of the quality of this service. According to the accuracy of the position determination, the symbol is changed in its representation, i.e., in shape, intensity, and/or color. This will be described in detail with reference to FIG. 5.

Thus, the mobile terminal MS shown in FIG. 3 incorporates navigation means, namely the navigation module GPS, with which it carries out the position determination itself. Alternatively, the position determination may be performed from the mobile radio network, in which case the mobile radio network communicates the accuracy of the position determination to the mobile terminal MS together with the indicator signal (LOC in FIG. 1). This information is then processed in the display controller DCT and results in a change in the representation of the symbol on the display DSP. In that case, too, the subscriber is informed at once not only of the availability of location-based services but also of the quality of these services.

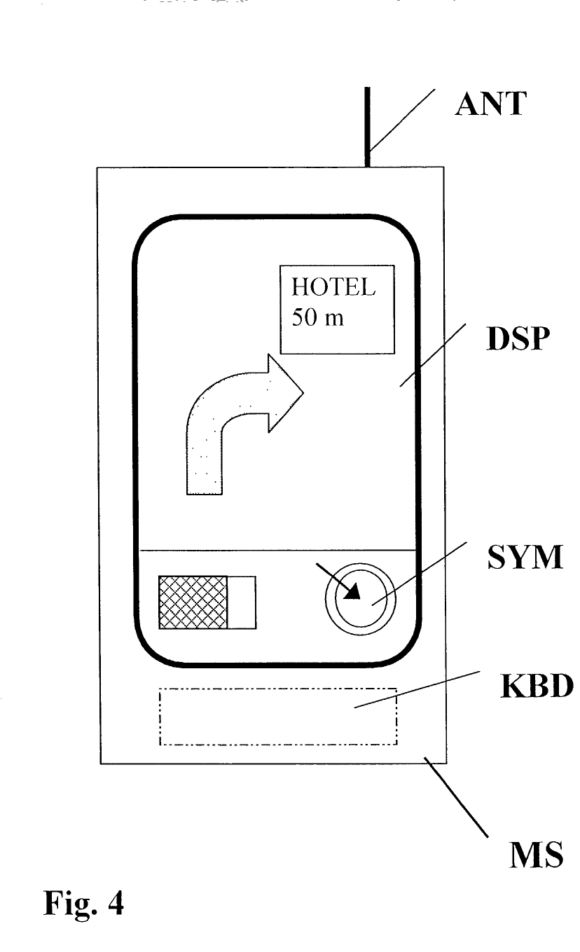

FIG. 4 is a front view of the mobile terminal MS with symbols according to the invention presented on the display DSP. The following elements of the mobile terminal MS are shown schematically: the antenna ANT, the display DSP, the keypad KBD, and a symbol SYM being presented on the display DSP as well as other symbols and representations.

As an example, a situation is shown where the subscriber is in a downtown area and is using a location-based service that is guiding him or her to a particular object, for instance to a hotel. The location-based service indicates on the display DSP, for instance by a right-hand-curved arrow or by text information, that the subscriber will find the hotel at a distance of 50 meters from his or her current location if he or she turns right into the next street. Also shown on the display DSP is a conventional symbol, namely a symbol for the battery condition. According to the invention, a new symbol SYM which indicates both the availability of the location-based service and the quality of this service is additionally presented on the display DSP. The availability is indicated, for example, by the presence of a symbolic arrow, and the quality by the number of several concentric rings.

These and other forms of representation of the symbol are illustrated in FIG. 5. In a first example a), an arrow has been chosen to indicate the availability of the location-based service. Also shown are concentric circles whose number indicates the quality of the service. At the first level S1, only the availability of the service is indicated. At levels S2, S3, and S4, the different qualities are indicated, with S2 representing the lowest quality level and S4 representing the highest quality level. Accordingly, the representation for level S2 has one ring, the representation for level S3 has two rings, and the representation for level S4 has three concentric rings. The subscriber thus recognizes without difficulty and right away that a location-based service is available and how high the quality of this service is. Level S2, for example, stands for a localization accuracy of about one or several kilometers; level S3 stands for an accuracy of one hundred or several hundred meters; and level S4 stands for an accuracy of a few meters.

A variant of the representation is illustrated by the example b) of FIG. 5. There, the availability of the location-based service is indicated by a symbolic hand, to which a first circle has already been added. For higher qualities, corresponding to levels S2 to S4, further circles are added. Finally, the third example c) of FIG. 5 shows a symbol which represents the geographical outline of a country to indicate that a location-based service is available per se. The accuracy corresponding to levels S3 to S4 is represented by an additional circle that covers a portion of the country shown and decreases in size as accuracy increases. In this example, the outline of Italy is shown; the circles narrow down the region around Rome according to accuracy levels S2, S3, and S4.

With the invention described, mobile subscribers are informed automatically, comprehensively, and quickly of the availability and quality of location-based services by indication on the display already before they wish to use a mobile service. Therefore, the use of the invention is of particular interest to mobile subscribers that travel a lot and need information at different places. It is also possible to inform the subscriber of the quality of a location-based service while he or she is using the service or only thereafter by displaying a corresponding symbol. This has the advantage that the subscriber can estimate the reliability of the user data and information sent to him or her. The transmission of the indicator signal need not necessarily be permanent; it con also take place intermittently and only on the occurrence of particular events, such as on turn-on of the mobile terminal, on a cell change, or on a change between services, applications, and the like. While preferred embodiments of the invention have been described, it is to be understood that various modifications may be made without departing from the scope of the invention.

For example, the symbol itself need not necessarily be a visually representable symbol. An audible indication in the form of particular signal tones is also conceivable. Also, a vibration alarm with particular patterns can call the subscriber's attention to the availability of location-based services. Assuming, for example, the subscriber requests a location-based service and this service is not available at his or her current location, then the subscriber will receive a specific audible signal or a vibration alarm as soon as he or she enters an area where the location-based service is offered by the mobile radio network. For the use of this alarming service, an additional charge may be made. The same applies analogously to the transmission of the indicator signal itself.

1. A mobile radio network which provides location-based services to mobile subscribers, comprising at least one base station, which is in radio communication with at least one mobile terminal which is used by one of the mobile subscribers, and network elements which estimate the mobile subscriber's current location and provide the location-based services, wherein the network elements cause the at least one base station to transmit an indicator signal which indicates that at least one location-based service is available, in order to indicate to the mobile subscribers the availability of the location-based service.

2. A mobile radio network as set forth in claim 1, wherein each of the base stations serve a cell, that the network elements comprise a radio network controller which controls the base stations and determines in which of the cells the mobile subscriber currently is, and that the network elements comprise a server which provides different location-based services to the cells.

3. A mobile radio network as set forth in claim 1, wherein the network elements determine a measure of the quality of the location-based service based on the method used and/or on the accuracy with which they estimate the mobile subscriber's current location, and that the at least one base station generates and transmits the indicator signal in such a manner that the indicator signal also indicates the quality with which the location-based service is available.

4. A mobile radio network as set forth in claim 3, wherein the network elements evaluate measured values from the base stations using a terrestrial navigation technique, particularly a triangulation technique, thereby estimating the mobile subscriber's current location and thus also determining the measure of the quality of the location-based service.

5. A mobile terminal enabling a mobile subscriber to use location-based services, comprising a receiver for receiving at least one radio signal from a mobile radio network, a display controller connected to the receiver, and a display connected to the display controller, wherein the receiver receives from the mobile radio network an indicator signal which indicates that a location-based service is available, and that the display controller and the display then generate a symbol on the display which indicates to the mobile subscriber the availability of the location-based service.

6. A mobile terminal as set forth in claim 5, wherein the indicator signal received by the receiver also indicates the quality with which the location-based service is available, and that the display controller and the display vary the shape, intensity, and/or color of the symbol in accordance with the indicated quality.

7. A mobile terminal as set forth in claim 5, wherein the radio signal received by the receiver contains video data by means of which the display controller and the display generate images on the display, that the received radio signal is combined with the indicator signal into a signal which contains the video data and indicator data, and that the display controller and the display generate the symbol within the images on the display, particularly in the form of a superimposed window.

8. A mobile terminal as set forth in claim 5, wherein the mobile terminal is connectable to a navigation device or comprises a navigation module which determines the current location and which indicates a measure of the quality of the location-based service based on the accuracy with which the navigation device or the navigation module determines the current location, and that the display controller and the display vary the shape, intensity, and/or color of the symbol in accordance with the indicated quality.

9. A symbol for presentation on a display of a mobile terminal which is used by a mobile subscriber in the service area of a mobile radio network, wherein the symbol indicates to the subscriber the availability of a location-based service which is provided by the mobile radio network.

10. A symbol as set forth in claim 8, in that by varying its shape, intensity, and/or color, the symbol indicates the quality with which the location-based service is available.

11. Use of a symbol for presentation on a display of a mobile terminal which is used by a mobile subscriber in the service area of a mobile radio network, wherein the symbol indicates to the subscriber the availability of a location-based service which is provided by the mobile radio network.
